(19) United States
(12) Patent Application Publication
(10) Pub. No.: US 2007/0160007 A1
(43) Pub. Date: Jul. 12, 2007

(54) METHOD AND DEVICE FOR COST-FUNCTION BASED HANDOFF DETERMINATION USING WAVELET PREDICTION IN VERTICAL NETWORKS

(76) Inventors: Li-Chun Wang, Hsin-Chu Hsien (TW); Ming-Bing Chen, Hsin-Chu Hsien (TW); Chang-Feng Lee, Tai-Nan City (TW)

Correspondence Address: NORTH AMERICA INTELLECTUAL PROPERTY CORPORATION, P.O. BOX 506, MERRIFIELD, VA, 22116, US

(21) Appl. No.: 11/306,798

(22) Filed: Jan. 11, 2006

(51) Int. Cl. H04Q 7/00

(52) U.S. Cl. 370/331; 455/405

(57) ABSTRACT

A method for performing a network handoff between different network communication providers for a wireless endpoint includes: calculating a first cost value for a first network detected by the wireless endpoint according to a first cost function calculation, calculating a second cost value for a second network detected by the wireless endpoint according to a second cost function calculation, utilizing a cost function based wavelet predictor to determine a network handoff time according to at least one of the first and second cost functions, and executing the network handoff between the first network and the second network at the network handoff time, wherein the cost function based wavelet predictor is for predicting future trends of various network characteristics.

### BACKGROUND OF THE INVENTION

1. Field of the Invention

The present invention relates to wireless network communications, more particularly, a method and device for producing an economical vertical network handoff using a cost function based wavelet predictor.

2. Description of the Prior Art

With recent advancements in RF (radio frequency) technologies and systems, wireless users possess a seemingly endless supply of wireless communication devices and information mediums to choose from. Some of the currently widely available wireless devices include: cellular telephones, personal desktop assistants (PDAs), pagers, and compact notebook computers. Each of these wireless devices may also further correspond to a specific wireless communications protocol, such as GSM, Bluetooth, WiFi (Wireless Fidelity), and WiMax. The popularity of wireless devices comes from their ease of use, their versatility, the geographical freedom they provide, and the vast amounts of information they are able to seamlessly exchange.

As the maturation process of wireless devices and technologies continue, we can expect the inclusion of key features to be integrated into the relevant devices. One such important feature is the ability for a single wireless device to be able to select from and communicate through different wireless transmission protocols. The ability for a wireless device or terminal to switch from one wireless provider to another is referred to as a “handoff”. A handoff can either refer to a horizontal handoff—where a wireless device connects to a different wireless provider of the same transmission protocol, or a vertical handoff, where it connects to a wireless provider of a different protocol. As wireless technologies progress, so will the requirement for seamless and efficient handoffs. However, the handoff between different wireless access networks and protocols possesses many dilemmas in design, computation and implementation.

There are many variables which come into play in a specific wireless communications network protocol, and as such, a seamless handoff is not a simple task. Communications encoding, bandwidth, transmission frequency, security encoding, access delay times, signal to noise ratio (SNR), and even airtime costs are just a few of the many considerations one must take into account before commencing with a handoff. The implementations of each of these variables vary from one protocol to another, further complicating the handoff decision and procedure. To successfully carry out a handoff, the wireless terminal or device must need to know first of all, when to switch from one network to another, and the different characteristics associated with the alternate protocol. For an overall beneficial handoff, the device also needs to make a decision on whether the handoff will result in an overall improvement with respect to the characteristics and performance of the current network.

Currently, there are no proposed methods to carry out a vertical handoff between wireless network providers. For horizontal handoffs, the current methods mainly utilize the perceived SNR to determine the handoff requirement. If an alternate network displays a higher signal to noise ratio than the currently utilized network, the wireless device would determine that a horizontal network handoff would be beneficial. Although in this case signal strength and reception should be improved, other critical characteristics, such as access delay times and airtime costs are overlooked, especially for the vertical handoffs between different types of communication protocols.

### SUMMARY OF THE INVENTION

A goal of the present invention is to provide a method to determine the feasibility of a vertical handoff in a wireless network communications environment. This greatly aids in the decision of whether or not to handoff to another vertical network. The method incorporates the usage of multiple characteristics of the current and competing network providers, and utilizes a wavelet transform to predict the trend of multiple characteristics of different network providers in the future. With the aid of wavelet prediction, the proposed method provides a more concise, accurate, and overall qualitative result to the feasibility and benefit of a potential handoff.

According to an exemplary embodiment of the present invention, a method for performing a network handoff between different network communication providers for a wireless endpoint is disclosed. The method comprises calculating a first cost value for a first network detected by the wireless endpoint according to a first cost function calculation, calculating a second cost value for a second network detected by the wireless endpoint according to a second cost function calculation, utilizing a cost function based wavelet predictor to determine a network handoff time according to at least one of the first and second cost functions, and executing the network handoff between the first network and the second network at the network handoff time, wherein the cost function based wavelet predictor is for predicting future trends of various network characteristics.

According to another exemplary embodiment of the present invention, a mixed type communications network is disclosed. The mixed type communications network comprises: a wireless endpoint, a first network being detectable by the endpoint, a second network being detectable by the endpoint, and a handoff module. The handoff module is utilized for calculating a first cost value for a first network detected by the wireless endpoint according to a first cost function calculation, for calculating a second cost value for a second network detected by the wireless endpoint according to a second cost function calculation, utilizing a cost function based wavelet prediction for determining a network handoff time according to at least one of the first and second cost functions, and for executing a network handoff between the first network and the second network at the network handoff time, wherein the cost function based wavelet prediction is for predicting future trends of various network characteristics.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a wireless endpoint interacting with various communication networks according to an exemplary embodiment of the present invention.

FIG. 2 shows exemplary plots of an arbitrary cost function, its wavelet transform coefficients, and wavelet transform residuals.

FIG. 3 is a flow chart diagram that illustrates a method for performing a network handoff between different network communication providers for a wireless endpoint according to an exemplary embodiment of the present invention.

FIG. 4 illustrates an embodiment of the method shown in FIG. 3 utilized for a multi network interface.

FIG. 5 shows a mixed type communications network capable of executing a network handoff according to an exemplary embodiment of the present invention.

### DETAILED DESCRIPTION

Most wireless terminals today employ a method for determining feasibility of a horizontal network handoff solely based on the perceived signal to noise ratio (SNR) of an alternative wireless communications network. As previously mentioned, characteristics such as bandwidth, access delay time, energy consumption, and monetary airtime costs are currently not taken into account. For a vertical handoff between communications providers, there are currently no methods available. The present invention improves on the existing infrastructure by providing a cost function based wavelet predictor to determine the feasibility of a vertical handoff to an alternative wireless communications network, while additionally taking into account these currently unutilized network characteristics.

The present invention makes use of a wavelet transform based predictor for use in time-scale signal analysis. Wavelet prediction employs a recursive algorithmic method utilizing a set of basis functions for analysis and modeling of the input signal. It allows for a signal presented in time domain form to be transformed and represented by the scale and time of the chosen basis functions. Wavelet functions are distinguished from other transformations in that they not only dissect signals into their basis functions, they also vary the scale at which the component frequencies are analyzed. The area of wavelet prediction is well known to those who are skilled in the art of signal analysis and image processing, and as such, is not discussed in any further detail.

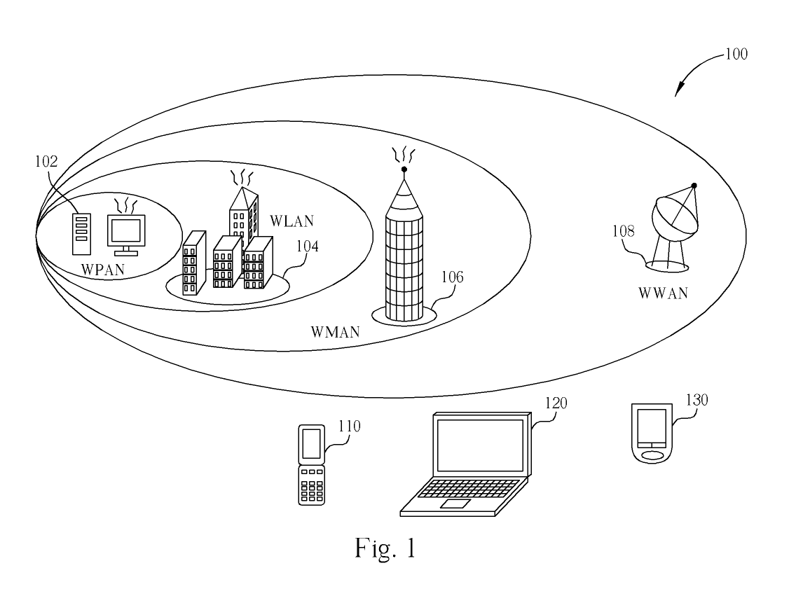

FIG. 1 shows a diagram of a wireless endpoint interacting with many potential wireless vertical communications networks. As shown in FIG. 1, the wireless endpoint may comprise of a cellular phone 110, a notebook computer 120, a handheld personal digital assistant (PDA) 130, or any other wireless communications device. These wireless devices may be used within a transmission area of a relevant network provider with sufficient SNR, providing that the communications medium is compatible. Vertical network providers may include a wireless personal area network (WPAN) 102, a wireless local area network (WLAN) 104, a wireless metropolitan network (WMAN) 106, or a wireless world area network (WWAN) 108. As FIG. 1 illustrates, the transmission region of the wireless world area network (WWAN) 108 encompasses every other network region, whereas the wireless personal area network (WPAN) 102 only contains its independent transmission region.

A cellular phone 110, for example, may typically only be used within the transmission vicinity of the wireless metropolitan network 106 because of its sole compatibility with this network. Therefore, if the cellular phone 110 leaves the vicinity of the wireless metropolitan network 106, it may lose communications with the network. A notebook computer 120 on the other hand may be compatible with either the wireless personal area network (WPAN) 102, wireless local area network (WLAN) 104, and wireless metropolitan network (WMAN) 106, and can therefore move and operate between the tree different vertical network types.

As the user of the notebook computer 120 moves from one region to another, the localized network characteristics may also change such that a vertical network handoff would be beneficial. The mobile terminal with multiple network access abilities has to determine if and when alternative anchor network switch to a new network is appropriate. Traditionally, the mobile terminal makes a handoff decision solely based on the received SNR, however in this method the device will consider other network characteristics such as bandwidth, access delay times, SNR ratio, power consumption, and monetary airtime costs.

In order to make an appropriate decision regarding a vertical network handoff, while taking into consideration all of the critical network characteristics, a cost function based wavelet predictor is employed in the present invention. The proposed mechanism is divided into the following three stages: a cost function calculation, a handoff search using a wavelet transform based cost function predictor, and dynamic execution of the vertical handoff.

Cost Function Calculation

To consider all the performance factors from different wireless network providers, a cost function calculation is used to combine these factors and provide an overall quantitative result. Equation (1) below suggests a formula to integrate factors such as received SNR, access delay time, bandwidth, power consumption and monetary cost into one mechanism according to an exemplary embodiment of the present invention.

$${Cost}^{n} = {W}_{SNR} \cdot N ( \frac{1}{{SNR}_{n}} ) + {W}_{delay} \cdot N ( {Delay}_{n} ) + {W}_{BW} \cdot N ( \frac{1}{{BW}_{n}} ) + {W}_{P} \cdot N ( {P}_{n} ) + {W}_{C} \cdot N ( {C}_{n} ) \qquad ( 1 )$$

where (SNRₙ) is the observed signal to noise ratio from a network n

(BWₙ) is the observed available bandwidth from a network n

(Delayₙ) is the observed latency time to switch to a network n

(Pₙ) is the observed power consumption from a network n

(Cₙ) is the observed unit monetary cost of usage from a network n and

$$N ( \frac{1}{{SNR}_{n}} )$$

is an arbitrary function of the signal to noise ratio from network n

$$N ( \frac{1}{{BW}_{n}} )$$

is an arbitrary function of the bandwidth from network n

N(Delayₙ) is an arbitrary function of latency time from network n

N(Pₙ) is an arbitrary function of the power consumption from network n

N(Cₙ) is an arbitrary function of the power consumption from network n

and W_{SNR} is a weighting factor for the arbitrary function of signal to noise ratio

W_{delay} is a weighting factor for the arbitrary function of latency time

W_{BW} is a weighting factor for the arbitrary function of bandwidth

W_{P} is a weighting factor for the arbitrary function of power consumption

W_{C} is a weighting factor for the arbitrary function of unit monetary cost

And Costⁿ is an arbitrary function to determine the overall cost for a network n based on the SNR, bandwidth, latency time, power consumption and unit monetary cost of the relevant network.

From the above equation (1), we can selectively assign a dynamic numerical value to each network classifying the overall cost of a network based on the critical network parameters. This will allow a mobile device or endpoint to establish a ranking amongst the available competing network providers, and make an appropriate selection for handoff based on the assigned classification.

Once a qualitative ranking of available wireless network providers is established, the wireless device or user can decide whether or not to proceed with a handoff based on the overall cost of each competing network, and the cost of the currently utilized anchoring network. Because the overall cost of each currently available network is reduced into a numerical value or ranking, the decision of whether to make a network handoff, and which alternative network to select is greatly simplified.

In one exemplary embodiment, a user would decide to switch to a competing network if the overall cost is perceived to be lower. Based on the equation in (1), a lower cost network would suggest an improvement in at least one of the critical network characteristics, and a subjectively overall improvement over the existing anchoring network. The different weighting factors of (1) can therefore be adjusted according to the user to specify which parameters are of greater or less importance in the overall cost calculation. For example, if unit monetary cost is the most important consideration of the network characteristics, the weighting factor W_{C} in (1) can be set higher than other weighting coefficients so the monetary network cost can take more precedence in the overall cost calculation. If signal to noise ratio, and latency time are considered most important, than W_{SNR} and W_{delay} can also be set higher than other weighting factors. In this manner, the overall cost equation (1) can be customized according to user preference to reflect the most important network characteristics in calculating the overall network cost.

In practice, the essential network parameters vary with time, and as such the overall cost value is expected to vary with time as well. Therefore, the overall cost equation of (1) can also be made a function of time, and can thereby be constantly updated for different wireless networks to provide a current and accurate ranking of alternative network providers. To deal with spikes and rapid fluctuations in the critical network parameters, one can employ a time averaging algorithm to calculate steady state overall cost values and more reliably classify relevant wireless networks. However, this time averaging algorithm is a time consuming process, which may postpone the handoff time and cause an interruption in communications. Thus, a wavelet transform based cost function predictor is proposed to deal with the spikes and rapid fluctuations of the cost function values and overcome the problems associated with the time averaging algorithm.

Handoff Search Using a Wavelet Transform Based Cost Function Predictor

Upon calculating and obtaining the current overall cost values for the available alternative network providers and establishing a ranking, the mobile endpoint activates a cost function predictor, which uses wavelet function transformations to analyze the history of overall cost functions and perform a search for a potential handoff.

Wavelet transforms are a multi-resolution transform, which use different resolution basis functions to analyze the input signal. As briefly described, a wavelet transform is a mathematical transform that converts a time domain signal into a domain composed by a set of basis function that can be generated by a predetermined mother wavelet function. Wavelet functions are distinguished from other transformations in that they not only dissect signals into a set of basis functions, they also vary the scale at which the basis functions are analyzed. The ability to vary the scale of the function as it addresses different bases makes wavelets better suited to signals with spikes or discontinuities over traditional transformations.

In this process, the input signal is partitioned into multiple coefficients and residual parts upon the wavelet transformation. The mobile terminal then would examine the residual parts (or residuals) to predict whether the mobile terminal is approaching a compatible network. If the mobile terminal approaches a preferable network, the overall cost function value will experience a sudden drop as proven through computer simulations. The sudden drop of the overall cost function generally corresponds to the residuals of the input signal having drastic spikes and variations. The mobile endpoint would then inspect the residuals of the wavelet transforms to confirm if a sudden drop had occurred. If an existing spike is found, and the target network is not the current one, the mobile terminal will perform a comparison of the overall cost function calculations, and carry out a network handoff if determined beneficial.

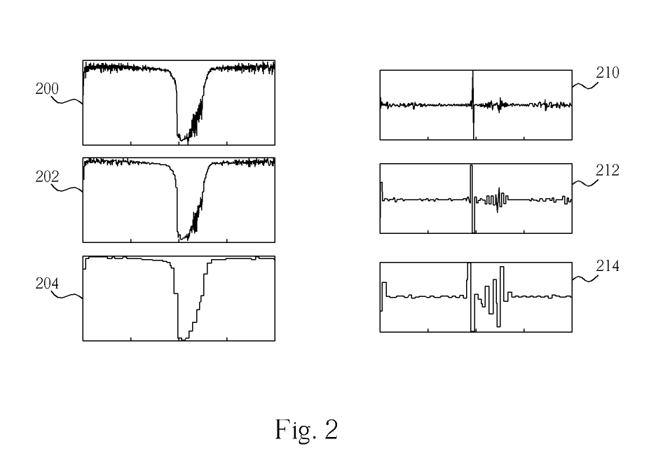

The input signal can be provided by the current anchor network provider or an alternative network provider. The network is analyzed for consistency and to ensure that it is performing above a preferred threshold level. If the performance drops beyond this level, or if the cost function surpasses a predetermined cost threshold, the device can proceed with a handoff to another provider. This is illustrated in the exemplary graphs of FIG. 2. An arbitrary plot of the cost function 200 vs. time for a network provider is shown. The network provider is typically an alternative network. The first coefficient 204, and the second coefficient 202 of the multiple coefficients which comprise the cost function 200 are also shown. The right hand column of graphs depict the first residual 214, the second residual 212, and the third residual 210 of the multiple residuals of the cost function 200. At the second time interval of the cost function 200 plot, a strongly sloped drop is noted. This large gradient is noted by various spikes at roughly the same time interval in the first residual 210, the second residual 212, and the third residual 214. Successive residuals will show the spike widening over an earlier period, and thus allow for an early prediction of an anticipated gradient. The rapid fluctuations in the residuals indicate that a preferable network may be located. Based on the values of the cost function and residual plots, the mobile endpoint can in advance determine if the network is with a set performance and cost function threshold, and decide upon a handoff to this network.

Simply put, the wavelet transform cost function predictor searches for a smooth slope in the cost function curve to determine consistency, and to monitor spikes or drops in the wavelet transform residuals. In this manner, a prediction for a possible handoff can be made earlier than otherwise possible, allowing for a faster and more accurate reaction to a potential network switch. This type of analysis provides much more detail and resolution than a simpler time domain based analysis, and greatly aids in an automated network switching scheme. Once a handoff candidate is located, and a determination has been made that the handoff would be beneficial, the device can proceed with a handoff.

Dynamic Execution of Network Handoff

When a determination has been made that a vertical handoff would be beneficial, or a reduction in the cost function would be achieved through a handoff, the system is configured to execute dynamic execution of the network handoff. The wireless device of multiple access point technology would then switch communications protocols to that of the handoff candidate, and then lock on the alternate vertical network provider for communications.

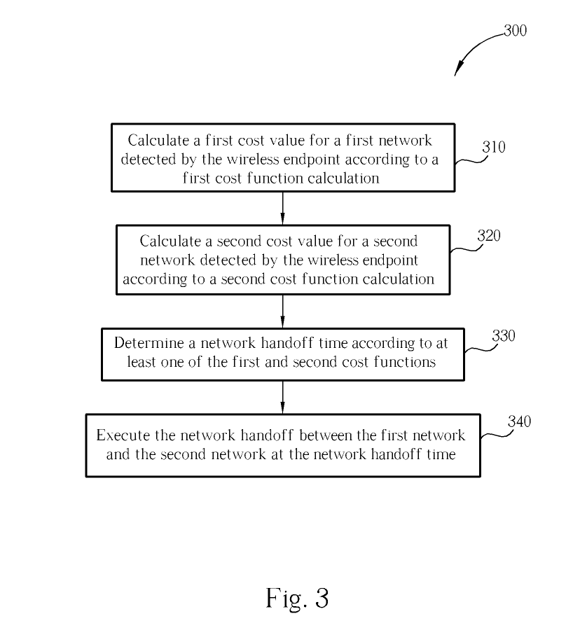

FIG. 3 displays a flow chart 300 which summarizes and illustrates the method proposed in the above three stage mechanism. Provided that substantially the same result is achieved, the steps of the flow chart 300 need not be in the exact order shown and need not be contiguous, that is, other steps can be intermediate. According to this embodiment, the method for performing a network handoff between different network communication providers for a wireless endpoint includes the following steps:

Step 310: calculate a first cost value for a first network detected by the wireless endpoint according to a first cost function calculation

Step 320: calculate a second cost value for a second network detected by the wireless endpoint according to a second cost function calculation

Step 330: utilize a cost function based wavelet predictor to determine a network handoff time according to at least one of the first and second cost functions

Step 340: execute the network handoff between the first network and the second network at the network handoff time.

Although the above example focuses on a network handoff between vertical networks, the same method can be applied for a horizontal network handoff, or a mixed configuration handoff. A mixed configuration handoff may consist of performing a cost function calculation and network search on both horizontal and vertical networks, and performing the network handoff on the most appropriate candidate.

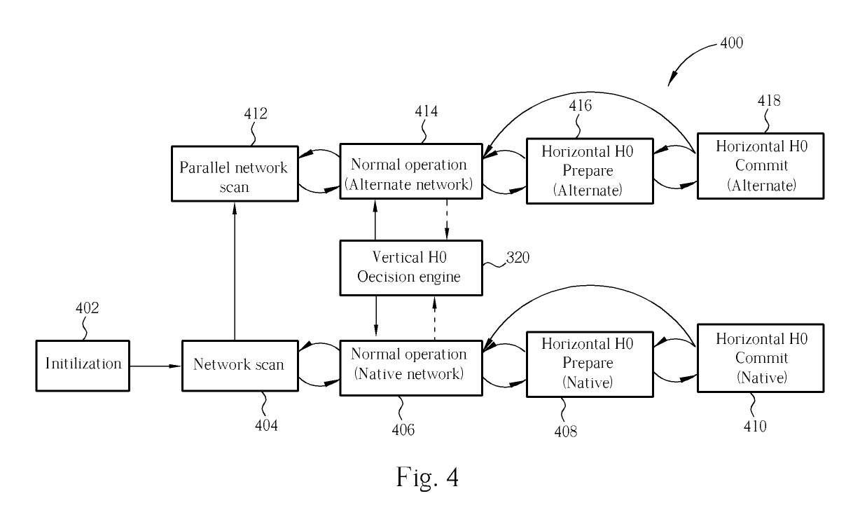

FIG. 4 illustrates an embodiment of the method used to initiate the process for a multi network interface. The multi network interface can be of vertical, horizontal, or of mixed network configuration. In this embodiment, only two different network protocols are described, however, please note that further embodiments may include a plurality of network protocols and providers. The process 400 begins with an initialization 402 stage of the wireless endpoint device. Upon initialization, a network scan 404 is performed to select a preferred native network communications protocol. Once a preferred network in the native network is located, the device undergoes normal operation 406 for the native network protocol. Under normal operation 406, the wireless device can perform the mechanism described above in 300 to identify an alternative network with a reduced cost function for communication.

To identify a preferable horizontal network, a horizontal handoff prepare 408 stage is entered under the native protocol. If an ideal candidate is found, then the system advances to the horizontal handoff commit 410 stage, otherwise if a suitable candidate is not found operation is reverted back to normal operation 406 under the previous provider. Under the horizontal handoff commit 410 stage under, if the handoff is executed successfully, normal operation 406 is again entered under the new horizontal network. If the execution of the handoff is unsuccessful, then operation reverts back the horizontal handoff prepare 408 stage where it may reattempt another handoff or search for another horizontal network.

After the initial network scan 404, the system can also perform an active/passive scan 412 stage in parallel. The active/passive scan 412 searches for a preferred alternative vertical network of a different protocol. If an alternate vertical network is utilized, it operates under the normal operation 414 mode for the alternate vertical network. In the same way as described previously for the preferred native network protocol, a horizontal handoff prepare stage 416, and a horizontal handoff commit stage 418 are utilized for the alternate vertical network, and operate horizontally in the same prescribed manner.

When under normal operation 406 for the native network, or under normal operation 414 for the alternate vertical network, the system also can enter a vertical handoff decision engine 420 mode to determine the necessity and perform a vertical handoff. The vertical handoff decision engine 420 also applies the 3 stage mechanism above, and makes a determination of whether to switch to a vertical network based on the cost function calculation. If the vertical handoff is determined to have a lower cost function, then the handoff is carried forth and the network can switch from normal operation 406 in the native network environment to normal operation 414 in the alternate vertical network configuration, or vice versa.

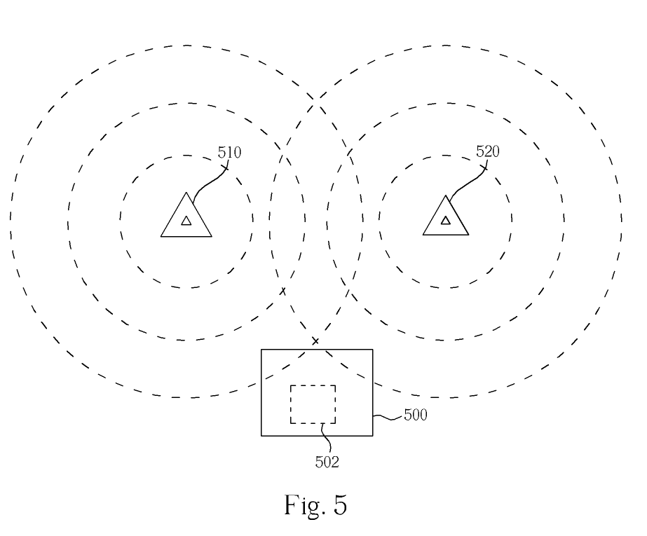

FIG. 5 shows a diagram illustrating a mixed type communications network capable of executing a network handoff. The handoff can be a vertical handoff, a horizontal handoff, or a mixed handoff of both types. A wireless endpoint 500 is within a detectable range of both a first network 510 and a second network 520, and currently operating within the communications protocol of the first network 510. The wireless endpoint 500 may contain a handoff module 502 within the wireless endpoint 500 which is responsible for executing a network handoff between the first network and the second network at a network handoff time. Although FIG. 5. shows the handoff module 502 integrated into the wireless endpoint 500, other embodiments may have the handoff module integrated in the first network 510, the second network 520, or another location external to the wireless endpoint 500.

The handoff module 502 operates by calculating a first cost value for the first network 510 the wireless endpoint 500 detects according to a cost function calculation specific to the first network 510. Afterwards, a second cost value is calculated for the second network 520 according to a cost function calculation specific to the second network 520. Upon calculating the cost functions for the two relevant networks, the handoff module 502 determines a network handoff time according to the first cost function, the second cost function or both. The network handoff time may be contingent on the second network 520 having a lower cost value than the first network 510, the cost value of the first network 510 surpassing a preset user value, the cost value of the second network 520 dropping below another preset user value, or another condition as desired by the user. Once the network handoff time is determined, the handoff module 502 is responsible for executing a network handoff between the first network and the second network at the network handoff time by switching the communications protocol of the wireless endpoint 500 from that of the first network 510, to the second network 520. In this way, the wireless endpoint 500 will communicate through the second network 520 as opposed to the first network 510.

By applying the three stages in the prescribed above mechanism, the present invention intelligibly and qualitatively makes an appropriate decision regarding a vertical network handoff. The prescribed method above can also allow for a seamless automatic dynamic handoff scheme. Again, the cost function calculation can be weighted by the user to value certain network characteristic parameters more heavily, or as uniquely as the user defines. An intelligible network handoff will ensure that overall cost is reduced, and that a users customized definition of performance is continually maximized. With the increasing number of wireless network providers available, an intelligible handoff will also provide a great convenience in switching networks, as it is capable of single-handedly and automatically making the handoff decision.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing a network handoff between different network communication providers for a wireless endpoint, the method comprising:
calculating a first cost value for a first network detected by the wireless endpoint according to a first cost function calculation;
calculating a second cost value for a second network detected by the wireless endpoint according to a second cost function calculation;
utilizing a cost function based wavelet predictor to determine a network handoff time according to at least one of the first and second cost functions; and
executing the network handoff between the first network and the second network at the network handoff time;
wherein the cost function based wavelet predictor is for predicting future trends of various network characteristics.

2. The method of claim 1, wherein a process of cost function calculation is utilized to determine the first and second cost values, the cost function calculation comprising:
utilizing a signal to noise ratio measurement,
utilizing a network latency time value,
utilizing a network bandwidth value,
utilizing a power consumption rate of the network, and
utilizing a unit monetary cost for the network.

3. The method of claim 2, wherein the process of the cost function calculation further comprises utilizing independent weighting factors to scale network variables according to a user preference to determine the first and second cost values.

4. The method of claim 1 further comprising calculating a plurality of additional cost values for a plurality of networks other than the first network as detected by the wireless endpoint according to a plurality of additional cost functions.

5. The method of claim 4, wherein the second network is a network that possesses a lowest cost value amongst the plurality of networks other than the first network as detected by the wireless endpoint.

6. The method of claim 1, wherein determining a network handoff time further comprises applying a wavelet transform analysis on the cost function to monitor a gradient that surpasses a maximum threshold level for the cost function.

7. The method of claim 1, wherein executing the network handoff further comprises the wireless endpoint switching communications protocols from a first network protocol to a second network protocol at the determined network handoff time.

8. The method of claim 7, wherein the second network protocol is of a different type than the first network protocol.

9. The method of claim 1, wherein the first network is the currently utilized anchoring network by the wireless endpoint.

10. The method of claim 1, wherein the second network is of a different protocol communication type than the first network.

11. A mixed type communications network comprising:
a wireless endpoint;
a first network being detectable by the endpoint;
a second network being detectable by the endpoint; and
a handoff module for calculating a first cost value for a first network detected by the wireless endpoint according to a first cost function calculation, for calculating a second cost value for a second network detected by the wireless endpoint according to a second cost function calculation, utilizing a cost function based wavelet prediction for determining a network handoff time according to at least one of the first and second cost functions, and for executing a network handoff between the first network and the second network at the network handoff time;
wherein the cost function based wavelet prediction is for predicting future trends of various network characteristics.

12. The mixed type communications network of claim 11, wherein the handoff module is for performing the first and second cost function calculations according to:
a signal to noise ratio measurement,
a network latency time value,
a network bandwidth value,
a power consumption rate of the network, and
a unit monetary cost for the network.

13. The mixed type communications network of claim 12, wherein the handoff module is further for performing the first and second cost function calculations comprising
utilizing independent weighting factors to scale network variables according to a user preference to determine the cost value of a network.

14. The mixed type communications network of claim 11, further comprising calculating a plurality of additional cost values for a plurality of networks other than the first network as detected by the wireless endpoint according to a plurality of additional cost functions.

15. The mixed type communications network of claim 14, wherein the second network is the network that possesses a lowest cost value amongst the plurality of networks other than the first network as detected by the wireless endpoint.

16. The mixed type communications network of claim 11, wherein determining a network handoff time further comprises applying a wavelet transform analysis on the cost function to monitor a gradient that surpasses a maximum threshold level for the cost function.

17. The mixed type communications network of claim 11, wherein executing the network handoff further comprises the wireless endpoint switching communications protocols from a first network protocol to a second network protocol at the determined network handoff time.

18. The mixed type communications network of claim 17, wherein the second network protocol is of a different type than the first network protocol.

19. The mixed type communications network of claim 11, wherein the first network is the currently utilized anchoring network by the wireless endpoint.

20. The mixed type communications network of claim 11, wherein the second network is of a different protocol communication type than the first network.
